(19) United States
(12) Patent Application Publication
(10) Pub. No.: US 2022/0164705 A1
(43) Pub. Date: May 26, 2022

(54) METHOD AND APPARATUS FOR PROVIDING INFORMATION BASED ON MACHINE LEARNING

(71) Applicant: EMRO CO., LTD., Seoul (KR)

(72) Inventors: Jae Min Song, Seoul (KR); Kwang Seob Kim, Seoul (KR); Ho Jin Hwang, Seoul (KR); Jong Hwi Park, Gyeonggi-do (KR)

(21) Appl. No.: 17/456,135

(22) Filed: Nov. 22, 2021

(30) Foreign Application Priority Data
Nov. 23, 2020 (KR) 10-2020-0158144

(51) Int. Cl. G06N 20/00

(52) U.S. Cl. CPC G06N 20/00

(57) ABSTRACT

According to various example embodiments, a method of providing information based on machine learning may include acquiring statement data related to purchase items, extracting a character string related to attributes of the items from the statement data, checking at least one item corresponding to an indirect cost among the items based on the character string by using a first learning model trained through machine learning, and checking cost category information of the at least one item based on the character string by using a second learning model trained through machine learning. Other example embodiments may be provided.

### CROSS-REFERENCE TO RELATED APPLICATION(S)

Any and all applications for which a foreign or domestic priority claim is identified in the Application Data Sheet as filed with the present application are hereby incorporated by reference under 37 CFR 1.57.

This application claims the benefit of Korean Patent Application No. 10-2020-0158144, filed on Nov. 23, 2020, in the Korean Intellectual Property Office, the disclosure of which is incorporated herein by reference.

### BACKGROUND

### Technical Field

The present disclosure relates to a method and apparatus for providing information based on machine learning. More particularly, the present disclosure relates to a method and apparatus for providing information related to statement data based on machine learning.

### Description of the Related Technology

Natural language processing (NLP) is one of the main fields of artificial intelligence in which research is performed to enable machines such as computers to imitate human language phenomena. With the development of machine learning and deep learning techniques in recent years, language processing research and development have been actively conducted to extract and utilize meaningful information from huge amounts of text through machine learning and deep learning-based natural language processing.

Meanwhile, companies need to standardize, integrate, and manage various types of pieces of information produced by the companies to improve work efficiency and productivity. For example, when items purchased by the companies are not systematically managed, duplicate purchases may occur and it may be difficult to search for an existing purchase history. At this time, in many cases, various pieces of information produced by the companies are text, so that there is a need for a method and system for providing information about an item based on natural language processing.

### SUMMARY

An aspect provides a method and apparatus for providing information about whether a purchase item is a classification object to which an indirect cost is applied and cost category information of the item, on the basis of statement data related to the item using at least one learning model trained through machine learning.

The technical object to be achieved by the present example embodiments is not limited to the above-described technical objects, and other technical objects which are not described may be inferred from the following example embodiments.

According to an aspect, there is provided a method of providing information based on machine learning including acquiring statement data related to purchase items, extracting a character string related to attributes of the items from the statement data, checking at least one item corresponding to an indirect cost among the items based on the character string by using a first learning model trained through machine learning, and checking cost category information of the at least one item based on the character string by using a second learning model trained through machine learning.

According to another aspect, there is provided an electronic apparatus including a memory, and a processor electrically connected to the memory, and the processor is configured to acquire statement data related to purchase items, extract a character string related to attributes of the items from the statement data, check at least one item corresponding to an indirect cost among the items from a feature vector using at least one learning model trained through machine learning, and check information about a cost category of the at least one item.

According to still another aspect, there is provided a computer-readable non-transitory recording medium recording a program for executing a method of providing information based on machine learning on a computer, and the method of providing information based on machine learning includes acquiring statement data related to purchase items, extracting a character string related to attributes of the items from the statement data, checking at least one item corresponding to an indirect cost among the items based on the character string by using a first learning model trained through machine learning, and checking cost category information of the at least one item based on the character string by using a second learning model trained through machine learning.

Specific details of other example embodiments are included in the detailed description and drawings.

According to various example embodiments, it is possible to provide information about whether a purchase item is a classification object, to which an indirect cost is applied, and cost category information of the item, on the basis of statement data related to the item using at least one learning model trained through machine learning. Thus, indirect cost-related information can be effectively analyzed and a cost reduction method for the indirect cost can be provided.

It should be noted that effects of the disclosure are not limited to the above-described effects, and other effects that are not described herein will be clearly understood by those skilled in the art from the description of the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram of an electronic apparatus according to various example embodiments of the present disclosure;

FIG. 2 is a diagram illustrating a method of acquiring information based on statement data according to an example embodiment;

FIG. 3 is a diagram for describing a method of providing information by the electronic apparatus according to an example embodiment of the present disclosure;

FIG. 4 is a flowchart related to the method of providing information by the electronic apparatus according to an example embodiment of the present disclosure;

FIG. 5 is a diagram for describing a method of creating a feature vector by the electronic apparatus according to an example embodiment of the present disclosure;

FIG. 6 is a diagram illustrating a user setting input screen for machine learning of the electronic apparatus according to an example embodiment of the present disclosure; and

FIG. 7 illustrates a user interface screen related to providing information based on machine learning by the electronic apparatus according to an example embodiment of the present disclosure.

### DETAILED DESCRIPTION

Terms used in example embodiments are general terms that are currently widely used while their respective functions in the present disclosure are taken into consideration. However, the terms may be changed depending on the intention of one of ordinary skilled in the art, legal precedents, emergence of new technologies, and the like. Further, in certain cases, there may be terms arbitrarily selected by the applicant, and in this case, the meaning of the term will be described in detail in the corresponding description. Accordingly, the terms used herein should be defined based on the meaning of the term and the contents throughout the present disclosure, instead of the simple name of the term.

Throughout the specification, when a part is referred to as including a component, unless particularly defined otherwise, it means that the part does not exclude other components and may further include other components.

The expression “at least one of a, b, and c,” should be understood as including only a, only b, only c, both a and b, both a and c, both b and c, or all of a, b, and c.

A node described throughout the specification refers to a redistribution point or endpoint of communication in a wireless network system, and may be interpreted as a generic term for a computer, a terminal, and devices belonging thereto, which are connected to a local network as basic elements of the network.

Example embodiments of the present disclosure that are easily carried out by those skilled in the art will be described in detail below with reference to the accompanying drawings. The present disclosure may, however, be implemented in many different forms and should not be construed as being limited to the example embodiments described herein.

Example embodiments of the present disclosure will be described in detail below with reference to the drawings.

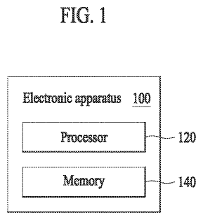

FIG. 1 is a configuration block diagram of an electronic apparatus according to various example embodiments of the present disclosure.

An electronic apparatus 100 according to various example embodiments is a system for managing item information, and may correspond to an apparatus configured to, for example, provide a service for classifying indirect cost data on the basis of statement data related to a purchase item.

Referring to FIG. 1, the electronic apparatus 100 may include a processor 120 and a memory 140.

The processor 120 may generally control components included in the electronic apparatus 100 and perform a series of operations for processing various functions implemented in the electronic apparatus 100. For example, when learning data is input, the processor 120 may train a learning model through machine learning using the corresponding learning data. In addition, when new statement data is input, the processor 120 may output information related to the statement data using the corresponding data as test data by using the learning model trained through the machine learning.

According to an example embodiment, the processor 120 may extract a character string related to attributes of items from the statement data. For example, the attribute-related character string may be extracted from text corresponding to at least a portion of company name information and account summary information as items including attribute (e.g., cost attribute) related information among a plurality of items included in the statement data.

The processor 120 may distinguish and classify items corresponding to an indirect cost and items corresponding to a direct cost from the statement data using at least one learning model (e.g., a first learning model) trained through machine learning.

In addition, the processor 120 may check cost category information of the item from the statement data using at least one learning model (e.g., a second learning model) trained through the machine learning.

For example, the processor 120 may check at least one item corresponding to the indirect cost on the basis of the character string, which is extracted from the statement data for a plurality of purchase items, through the first learning model. In addition, on the basis of the character string, cost category information about at least one item, which is classified as the indirect cost, may be checked through the second learning model.

In order to input the character string extracted from the statement data into the predetermined learning model, the processor 120 may check character elements constituting the character string and generate a matrix on the basis of vector information corresponding to each of the character elements. In addition, the processor 120 may create a feature vector corresponding to the character string from the matrix using at least one set filter. The processor 120 may input the feature vector as learning data or test data into the learning model.

The processor 120 may create the feature vector by embedding the character string into a character unit on the basis of each of the character elements constituting the character string, and through this, the processor 120 may check item-related information, so that the processor 120 may provide the item-related information regardless of the type of the character elements (e.g., English characters, Korean characters, special characters, or space characters) constituting the character string. In addition, even though at least one misspelling and/or omission is included in the character string, high accuracy data (e.g., item-related information) may be calculated.

Meanwhile, according to an example embodiment, as a method for the processor 120 to train at least one learning model (e.g., the first learning model and/or the second learning model) through machine learning, each of second statement data for second purchase items, information about whether the second items belong to the indirect cost, and cost category information of the second items may be acquired and used as learning data by the processor 120. At this time, the second statement data related to the second purchase items may correspond to previous-year statement data of a specific company. That is, the processor 120 may obtain in advance the previous-year statement data and information (e.g., information about whether each item corresponds to the indirect cost and cost category information of the each item) related thereto of the specific company prior to analyzing current-year statement data of the specific company, and through this, the processor 120 may train at least one learning model, and analyze the current-year statement data through the trained learning model to provide information related thereto.

Meanwhile, the processor 120 may use the statement data corresponding to at least one of the items (e.g., 80% of the items) of a predetermined ratio of the previous-year statement data as learning data, and use the statement data corresponding to the remaining items (e.g., the remaining 20% of the items) as verification data for verifying the reliability of the learning model trained through the learning data.

According to another example embodiment, the processor 120 may not acquire separate information related to the previous-year statement data and the processor 120 may perform the analysis described above and train a learning model to be used for analyzing the entire statement data using at least a portion of the current-year statement data for which the information is to be checked. For example, the processor 120 may check similarity information between the plurality of purchase items through a third learning model trained through machine learning, and determine at least one sample item (e.g., 20% of the items) from a plurality of items on the basis of the similarity information. The processor 120 may acquire indirect cost-related information for the at least one sample item, train the learning model using the indirect cost-related information as learning data, and analyze the statement data corresponding to the remaining items excluding the sample items.

The memory 140 may be electrically connected to the processor 120 and may store instructions related to operations of the processor 120. In addition, various pieces of data (e.g., the learning data, the instructions for the machine learning, the learning model-related data (e.g., the first learning model, the second learning model, parameter-related data), the information obtained using the learning model (e.g., the feature vector-related information, the indirect cost data, the cost category information of the indirect cost item, or the like) used by the electronic apparatus 100 may be stored.

Although not illustrated in FIG. 1, the electronic apparatus 100 according to various example embodiments may further include one or more of a communication module configured to transmit the information stored in the memory 140 or predetermined information processed by the processor 120 to another apparatus or receive predetermined information, which is transmitted to the electronic apparatus 100, from another apparatus, an input module configured to receive various user inputs, and a display configured to display information processed by the electronic apparatus 100 or a user interface provided by the electronic apparatus 100.

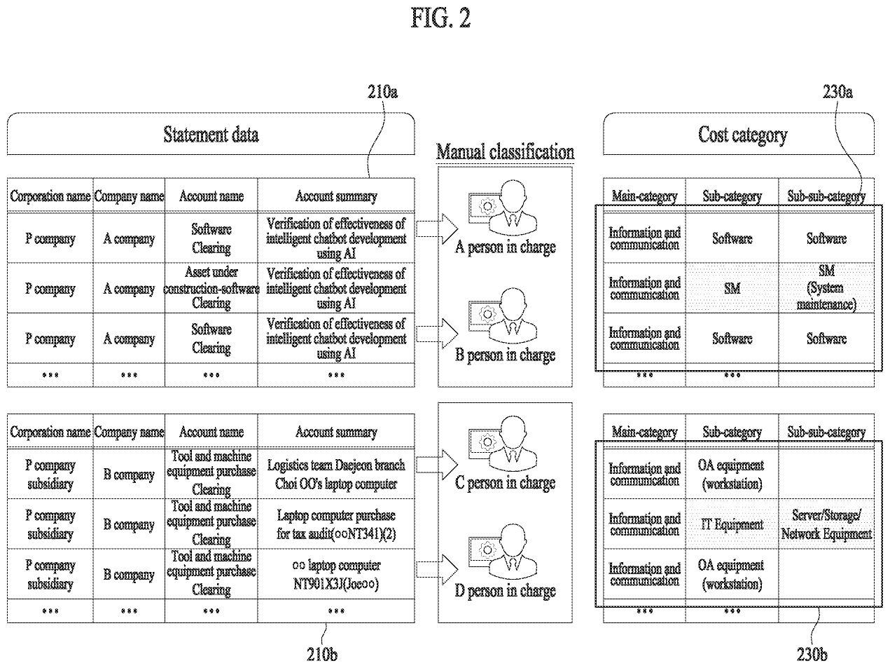

FIG. 2 is a diagram for describing a method of acquiring information based on statement data according to an example embodiment.

Referring to FIG. 2, statement data including information about items purchased by a specific company may include direct cost items and indirect cost items. An indirect cost accounts for a significant proportion of total expenditures of the company, and it is highly likely that costs may be reduced for each type by analyzing detailed items of the indirect cost, and thus, the company may want to manage and review purchase items corresponding to the indirect cost for each detailed category.

To this end, persons in charge (or workers), who need to check indirect cost item information for the company, may analyze and manage information related to purchase items corresponding to the indirect cost through operations of acquiring information about the indirect cost using the statement data and classifying the purchase items corresponding to the indirect cost for each cost category specifically they belong to. As such, operations of extracting the indirect cost items from the statement data, and distinguishing the cost category of each of the items may be generally performed manually by a plurality of persons in charge.

For example, pieces of purchase-related statement data 210a and 210b of the specific company may include items of a company name (corporation name) (e.g., a P company, a P company subsidiary, and the like in FIG. 2) or department name of the corresponding company, a name of a supplier that has supplied each item (e.g., an A company, a B company, and the like in FIG. 2), an account name related to the purchase item (e.g., “Software clearing,” “Asset under construction-software clearing,” “Tool and machine equipment purchase clearing,” and the like in FIG. 2), and an account summary (or cost description) (e.g., “Verification of effectiveness of intelligent chatbot development using AI,” “Laptop computer purchase for tax audit,” and the like in FIG. 2) describing a purchase purpose or the like of the purchase item. In addition, various types of pieces of information such as a company code, a department code, an invoice date, an invoice summary, an accounting date, and the like may be further included in the statement data.

A plurality of persons in charge (e.g., “A person in charge,” “B person in charge,” “C person in charge,” and “D person in charge”) may check information about the purchase items of the statement data 210a and 210b, and identify whether each of the items corresponds to the indirect cost item. In addition, when the items correspond to the indirect cost item, the persons in charge may specifically enter information 230a and 230b related to the cost category to which each of the items corresponds. For example, the cost category may include a plurality of layered subcategories, such as a main-category, a sub-category, and a sub-sub-category. For example, the sub-category may correspond to a lower category of the main-category, and the sub-sub-category may correspond to a lower category of the sub-category.

As described above, the operation of deriving the cost category information related to the items corresponding to the indirect cost from the statement data may be performed manually by the plurality of persons in charge. In this case, there may be a case in which it is not clear which cost category a specific item belongs to, and there may be a possibility that the specific item is erroneously determined as belonging to another category even looking at the statement data related to the same item depending on the person in charge. For example, even when account information is the same as “Verification of effectiveness of intelligent chatbot development using AI,” the person in charge may classify the corresponding item as an item of “Information and communication>>Software>>Software,” and the B person in charge may classify the corresponding item as an item of “Information and communication>>SM (system maintenance)>>SM.” As such, the data classified according to unclear criteria is less accurate and thus may be an error factor in the indirect expenditure cost analysis.

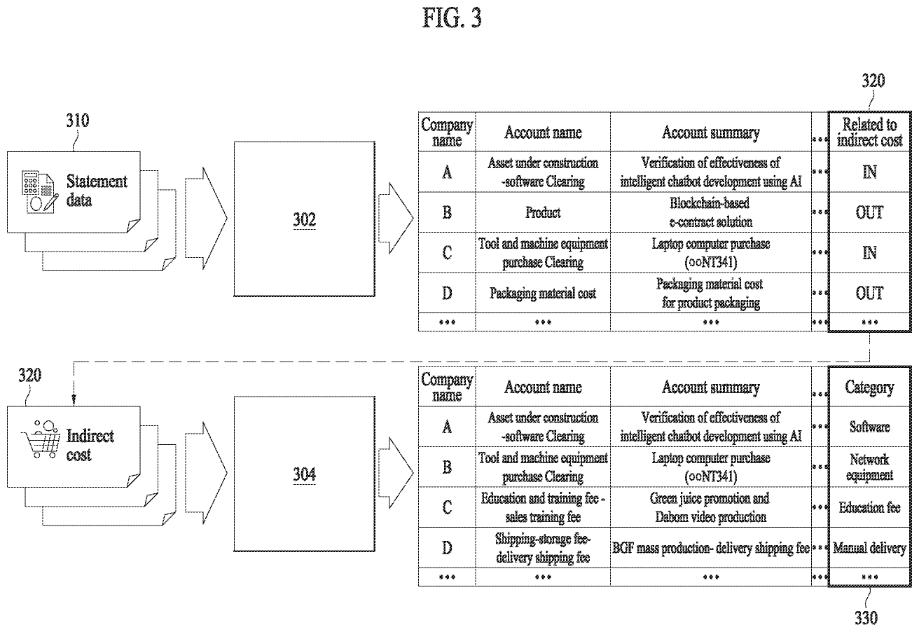

FIG. 3 is a diagram for describing a method of providing information by the electronic apparatus according to an example embodiment of the present disclosure.

Referring to FIG. 3, the electronic apparatus 100 according to various example embodiments may acquire indirect cost data 320 related to an indirect cost from statement data 310 related to a plurality of purchase items using at least one learning model (e.g., a first learning model 302 and a second learning model 304) trained through machine learning, and may also check cost category information 330 of the purchase items belonging to the indirect cost data 320 and provide the corresponding information.

As described above, the statement data 310 may include information related to the purchase of the plurality of items purchased by a specific company, and the plurality of items may be classified into a direct cost and an indirect cost.

The electronic apparatus 100 may acquire data 320 of at least one purchase item related to the indirect cost among the plurality of purchase items corresponding to the statement data 310 using the first learning model 302. For example, the electronic apparatus 100 may extract text information corresponding to at least a portion of company name information and account summary information as items related to attributes of the items among various pieces of item information included in the statement data 310. In addition, the electronic apparatus 100 may form the text information corresponding to at least a portion of the company name information and the account summary information as one character string and then create a feature vector corresponding to the character string, and may check the indirect cost-related information 320 corresponding to the feature vector using the first learning model 302.

In addition, the electronic apparatus 100 may check the cost category information of the items from the statement data 320 of the item corresponding to the indirect cost among the plurality of items.

For example, the electronic apparatus 100 may use the feature vector corresponding to the character string, which is extracted from text information related to the attribute of the item, to check the cost category information corresponding to the feature vector using the second learning model 304. In relation to the cost category information, the example embodiment including only one category is illustrated in FIG. 3, but according to various example embodiments of the present disclosure, the cost category information may include information corresponding to a plurality of hierarchical categories such as a main-category, a sub-category, and a sub-sub-category as described above.

As described above, the electronic apparatus 100 may analyze the statement data on the basis of certain criterion determined through machine learning to provide information about whether the statement data corresponds to the indirect cost, and cost category information, so that data reliability related to the indirect cost expenditure analysis may be ensured.

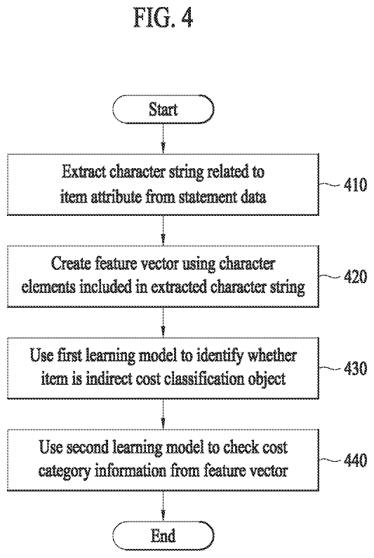

A detailed operation method related to the method of providing information by the electronic apparatus 100 according to various example embodiments of the present disclosure will be described below with reference to FIG. 4 and the like.

FIG. 4 is a flowchart related to the method of providing information by the electronic apparatus according to an example embodiment of the present disclosure. More particularly, FIG. 4 is a diagram related to a method of providing information based on machine learning by electronic apparatus 100.

Referring to FIG. 4, the method of providing information according to various example embodiments may include, first, extracting a character string related to an attribute of an item from statement data (e.g., the statement data 310 of FIG. 3) in operation 410.

The electronic apparatus 100 may acquire predetermined statement data related to a purchase item prior to performing operation 410. For example, the statement data may correspond to statement data including text information in an unstructured form, in which a purchase item corresponding to an indirect cost needs to be selected and which is an operation target on which an operation of determining a cost category of the corresponding item is to be performed.

In the statement data, various pieces of information related to the purchased item may be included. In operation 410, the electronic apparatus 100 may extract a predetermined character string related to the attribute of the item from at least one of various pieces of unstructured text information included in the statement data. For example, the electronic apparatus 100 may extract the predetermined character string related to the attribute of the item in a manner for concatenating text information included in company name information and account summary information of the corresponding item among various items included in the statement data.

In operation 420, the electronic apparatus 100 may create a feature vector, which is to be used as input data (e.g., learning data or test data) for a learning model, using character elements included in the extracted character string. That is, the electronic apparatus 100 may train a specific learning model through the machine learning by inputting the feature vector acquired in operation 420 to the learning data, or may input the feature vector as the test data to a specific learning model trained through the machine learning to check result information (e.g., information about whether relates to the indirect cost, and cost category information) corresponding to the feature vector.

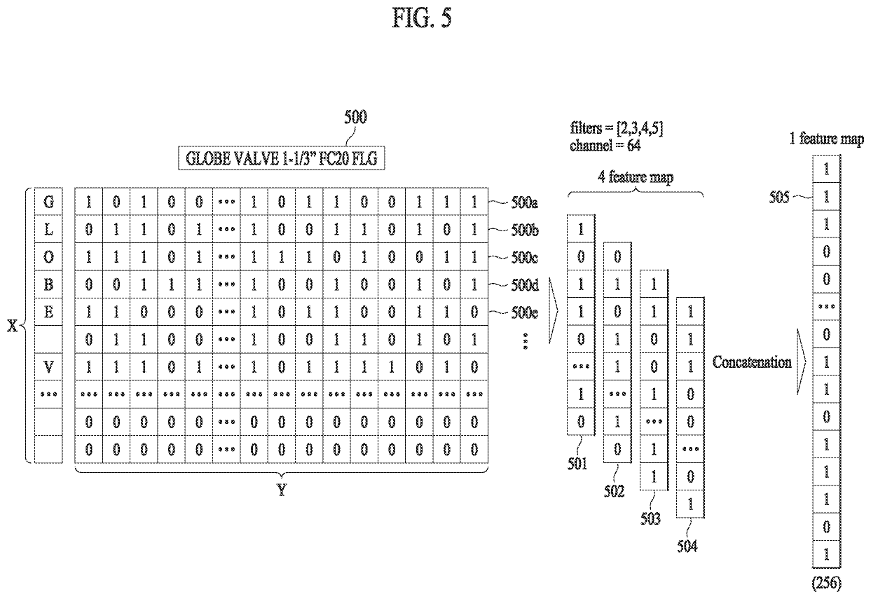

For example, the character elements included in the character string extracted in operation 410 may include at least a portion of English characters, Korean characters in syllable units, and special characters, and may also include space characters. The electronic apparatus 100 may check an index number corresponding to each of the character elements constituting the character string in operation 420, check vector information corresponding to the index number, and create a feature vector corresponding to the character string through machine learning based on the vector information. The process of creating the feature vector of operation 420 will be described in detail below with reference to FIG. 5.

Next, in operation 430, the electronic apparatus 100 may use at least one learning model (e.g., the first learning model 302, see FIG. 3) trained through machine learning to identify whether the purchase item corresponding to the feature vector is a classification object to which the indirect cost is applied. That is, the electronic apparatus 100 may input the feature vector generated in operation 420 into the first learning model 302 using the feature vector as the test data, and check whether the item corresponding to the feature vector corresponds to an indirect cost item. The first learning model 302 may correspond to the learning model previously trained through machine learning using statement data for a specific purchase item and information indicating whether the purchase item corresponds to the indirect cost item as the learning data.

In addition, in operation 440, the electronic apparatus 100 may check the cost category information of the item corresponding to the feature vector using at least one learning model (e.g., the second learning model 304, see FIG. 3) trained through machine learning. For example, the electronic apparatus 100 may input the feature vector generated in operation 420 into the second learning model 304 using the feature vector as the test data, and through this, the electronic apparatus 100 may obtain the cost category information of the item corresponding to the feature vector. The second learning model 304 may be previously trained through machine learning using the statement data for the specific purchase item and the cost category information to which the purchase item belongs as the learning data.

FIG. 5 is a schematic diagram for describing a method of creating a feature vector by the electronic apparatus according to an example embodiment of the present disclosure.

Referring to FIG. 5, the electronic apparatus 100 may extract a predetermined character string related to an attribute of an item from statement data.

For example, as shown in FIG. 5, the electronic apparatus 100 may extract a character string 500 of “GLOBE VALVE SIZE 1½″FC-20 FLG” as attribute-related information included in the statement data. At this time, the extracted character string 500 may be composed of X (e.g., 300) or less character elements including a space character and a special character.

The electronic apparatus 100 may store in advance an index number corresponding to each of the character elements and an index dictionary (or table), in which the character element is mapped, in the memory 140. The electronic apparatus 100 may use the index dictionary to perform a pre-processing operation of converting the character string 500 into a predetermined form enabling machine learning to be performed, and may use the index dictionary as a key value that may check what character elements the specific vector information means.

The character elements and the index numbers respectively corresponding to the character elements may be used to extract a multi-dimensional feature vector through an embedding process.

For example, the character elements (e.g., “G,” “L,” “O,” “B,” “E,” and the like) constituting the character string 500 may be converted into the form of the index number (not shown) corresponding to each of the character elements, and the index number (not shown) may be converted again into Y-dimensional vector information (e.g., 30-dimensional embedding size vector) (e.g., 500a, 500b, 500c, 500d, 500e, and the like) and expressed. The electronic apparatus 100 may determine an optimized combination of the vector information (e.g., 500a, 500b, 500c, 500d, 500e, and the like) corresponding to the character elements (or the index numbers) through machine learning. Accordingly, as shown in FIG. 5, the character string 500 may be expressed in the form of a matrix of X*Y.

Meanwhile, the electronic apparatus 100 may apply a convolution neural network (CNN) algorithm to the matrix. Specifically, the electronic apparatus 100 may set an arbitrary filter and use the filter to learn features of the matrix to obtain a specific dimensional feature vector (e.g., a 256-dimensional feature vector 505 shown in FIG. 5).

For example, in an example embodiment of the present disclosure, the electronic apparatus 100 may learn features (e.g., 501, 502, 503, and 504) corresponding to vector information corresponding to at least a portion (e.g., a combination of character elements of 2, 3, 4, and 5 units adjacent to each other in the character string) of the character elements constituting the character string by setting the CNN filter numbers as [2, 3, 4, and 5].

Further, the electronic apparatus 100 may set the number of channels (e.g., “channel=64”) corresponding to the dimension of the features (e.g., 501, 502, 503, and 504), which are to be learned, using each of the filters. Thus, the features (e.g., 501, 502, 503, and 504) obtained by using the respective filters may be implemented with vectors of the dimensions (e.g., 64 dimensions) that correspond to each of the channels.

In addition, the electronic apparatus 100 may concatenate the features in a channel direction, and finally, may obtain one feature vector corresponding to the character string. The feature vector may correspond to dimensions (e.g., 256 dimensions) corresponding to the product of the number (e.g. four in the case of filters with numbers “2,” “3,” “4,” and “5”) of the filters and the number of the channels (e.g., 64 dimensions).

The electronic apparatus 100 according to various example embodiments may be used for expressing learning data (e.g., the character string extracted from the statement data) in the form of text as a feature vector 505 in the same manner as described above and for training at least one learning model (e.g., the first learning model and the second learning model) using the feature vector 505.

Further, the electronic apparatus 100 may also express test data (e.g., the character string extracted from the statement data) in the form of text as the feature vector 505 in the same manner as described above and provide predetermined information (e.g., the information about whether corresponds to the indirect cost and the cost category information) using the at least one learning model (e.g., the first learning model and the second learning model).

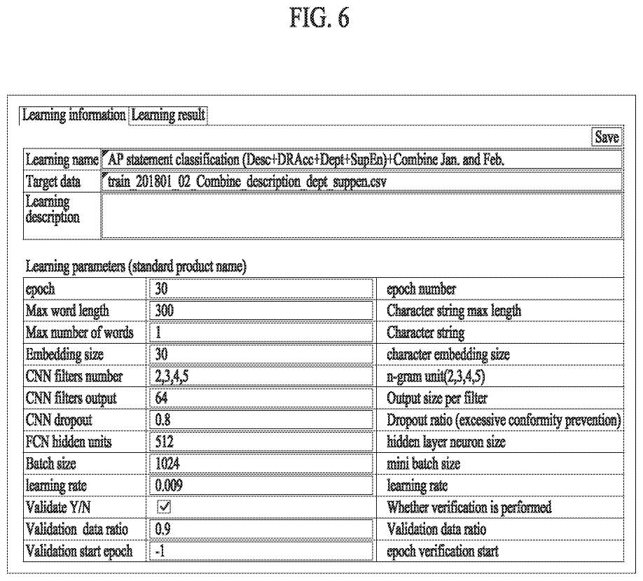

FIG. 6 is a schematic diagram illustrating a user setting input screen for machine learning of the electronic apparatus according to an example embodiment of the present disclosure.

Referring to FIG. 6, the electronic apparatus 100 according to various example embodiments may receive learning data for machine learning and user inputs regarding training parameters related to the machine learning condition. The electronic apparatus 100 may improve the performance of the learning model by adjusting the training parameters based on the user input.

For example, the electronic apparatus 100 may include, as the training parameters, at least one of “epoch number” (e.g., 30), “Max word length” (e.g., 300), “Max number of words” (e.g., 1), “Embedding size” (e.g., 30 dimensions), “CNN filters number” (e.g., [2, 3, 4, 5]), “CNN filters output” (e.g., 64 dimensions), “CNN dropout” (e.g., 0.8), “FCN hidden units” (e.g., 512), “Batch size” (e.g., 1024), and “learning rate” (e.g., 0.009).

In particular, in relation to the learning model for checking whether corresponds to the indirect cost from the statement data or checking the cost category information, the electronic apparatus 100 according to various example embodiments of the present disclosure may improve the performance of the learning model by adjusting items of “epoch number,” “CNN filters number,” “CNN filters output,” “CNN dropout,” “FCN hidden units,” “Batch size,” and “learning rate.”

For example, “epoch” relates to the number of learning iterations, when the number of pieces of learning data (e.g., statement data related to the purchase items, information about whether each of the items corresponding to the statement data corresponds to the indirect cost, information about the cost category) is large, the electronic apparatus 100 may set “epoch number” to be large. “CNN filters number” corresponds to the number of characters (n-gram) of the character elements to be analyzed, and when “filters number” is two, this may mean that the electronic apparatus 100 analyzes the character elements included in the character string in units of two characters to extract features. “CNN filters output” may correspond to the number of dimensions of the vector representing features that are extracted through the filters. “CNN dropout” may mean learning by reducing learning nodes by as much as a particular ratio to prevent overfitting. “FCN hidden units” may correspond to the number of hidden units in fully connected network-based learning, and “Batch size” may correspond to the number of pieces of data processed in parallel during the learning. “Learning rate” is a variable used for adjusting a learning speed, and “Learning data” may be set to a small value as the number of pieces of learning data increases and a difference between the pieces of learning data decreases.

In addition, the learning parameters may further include at least one of whether to perform verification on the learning model, a data rate for performing the verification on the learning model, or a verification start epoch of the learning model, and other parameters may be provided to be adjustable according to other system design requirements.

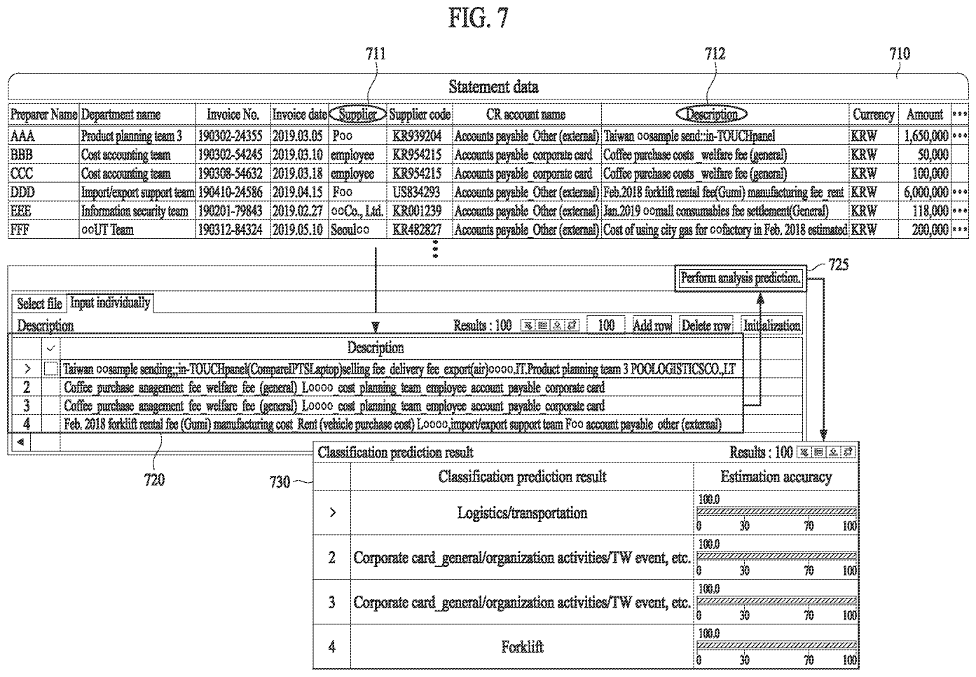

FIG. 7 is an exemplary diagram of a user interface screen related to providing information based on machine learning by the electronic apparatus according to an example embodiment of the present disclosure.

Referring to FIG. 7, the electronic apparatus 100 may obtain statement data 710 related to one or more purchase items, may extract text information 711 (e.g., “Supplier”) related to an attribute of the item from the statement data 710, and may extract predetermined character strings 720 from account summary information 712 (e.g., “Description”). The character strings may correspond to a character string set corresponding to each item.

In an example embodiment, the electronic apparatus 100 may receive a user input for an execution button 725 (e.g., “analysis prediction execution”) for providing information. In addition, the electronic apparatus 100 may perform operations for providing information based on machine learning according to various example embodiments of the present disclosure based on a user input, and provide classification prediction result information 730 related to each purchase item(s) through a screen.

For example, the electronic apparatus 100 may classify items corresponding to an indirect cost among a plurality of purchase items, and may provide cost category information of each of the items corresponding to the indirect cost as the classification prediction result information 730.

In addition, the electronic apparatus 100 may calculate accuracy information (e.g., 99.2% or 100%) related to a classification prediction result of the provided cost category information to provide the accuracy information written together with the cost category information. In an example embodiment, the electronic apparatus 100 may check similarity information between the items based on the statement data and may provide the accuracy-related information on the basis of the similarity information. For example, the electronic apparatus 100 may check the similarity information between the items using a third learning model trained through machine learning to provide the accuracy-related information.

The electronic apparatus (e.g., processor 120) according to various example embodiments of the present disclosure may include a processor, a memory for storing and executing program data, a permanent storage such as a disk drive, a communication port for communicating with external device.

Meanwhile, the methods according to various example embodiments of the present disclosure may be implemented with software modules or algorithms and may be stored as program instructions or computer-readable codes executable on a processor on a computer-readable recording medium. Examples of the computer-readable recording medium include magnetic storage media (e.g., read-only memory (ROM), random-access memory (RAM), floppy disks, hard disks, and the like), optical recording media (e.g., compact disc read-only memories (CD-ROMs), or digital versatile discs (DVDs)), and the like. The computer-readable recording medium may also be distributed over network coupled computer systems so that the computer-readable codes are stored and executed in a distributive manner. The media may be readable by the computer, stored in the memory, and executed by the processor.

The present example embodiment may be described in terms of functional block components and various processing operations. Such functional blocks may be implemented by any number of hardware and/or software components configured to perform the specified functions. For example, these example embodiments may employ various integrated circuit (IC) components, e.g., memory elements, processing elements, logic elements, look-up tables, and the like, which may perform various functions under the control of one or more microprocessors or other control devices. Similarly, where components are implemented using software programming or software components, the present example embodiments may be implemented with any programming or scripting language including C, C++, Java, Python, or the like, with the various algorithms being implemented with any combination of data structures, processes, routines or other programming components. However, such languages are not limited, and program languages that may be used to implement machine learning may be variously used. Functional aspects may be implemented in algorithms that are executed on one or more processors. In addition, the present example embodiment may employ conventional techniques for electronics environment setting, signal processing and/or data processing, and the like. The terms “mechanism,” “element,” “means,” “configuration,” and the like may be used in a broad sense and are not limited to mechanical or physical components. The term may include the meaning of a series of routines of software in conjunction with a processor or the like.

The above-described example embodiments are merely examples and other example embodiments may be implemented within the scope of the following claims.

What is claimed is:

1. A method of providing information based on machine learning, the method comprising:
acquiring statement data related to purchase items;
extracting a character string related to attributes of the items from the statement data;
checking at least one item corresponding to an indirect cost among the items based on the character string by using a first learning model trained through machine learning; and
checking cost category information of the at least one item based on the character string by using a second learning model trained through machine learning.

2. The method of claim 1, wherein the extracting of the character string related to the attributes of the items comprises extracting the character string using text corresponding to at least a portion of company name information and account summary information of the items, which are included in the statement data.

3. The method of claim 1, further comprising:
generating a matrix corresponding to character elements included in the character string through machine learning; and
creating a feature vector corresponding to the character string from the matrix using at least one filter,
wherein the feature vector is input to the first learning model and the second learning model as test data.

4. The method of claim 3, wherein the character elements included in the character string include at least a portion of English characters, Korean characters, and special characters.

5. The method of claim 1, further comprising:
determining a portion of the items as sample items;
extracting a sample character string related to attributes of the sample items from the statement data; and
acquiring information about whether the sample items correspond to the indirect cost, and cost category information of the sample items,
wherein the first learning model is trained using the sample character string and the information about whether the sample items correspond to the indirect cost as first learning data, and
the second learning model is trained using the sample character string and the cost category information of the sample items as second learning data.

6. The method of claim 5, wherein the determining of the sample items comprises:
checking similarity information between the purchase items based on the character string using a third learning model trained through machine learning; and
determining, as the sample items, items corresponding to a predetermined ratio among the items based on the similarity information between the items, which is checked from the statement data.

7. The method of claim 1, further comprising:
prior to acquiring of the statement data related to the purchase items, acquiring second statement data related to second purchase items;
acquiring information about whether the second purchase items correspond to the indirect cost, and cost category information; and
extracting a character string related to attributes of the second purchase items from the second statement data,
wherein the first learning model is trained using the character string of the second purchase items and the information about whether the second purchase items correspond to the indirect cost as first learning data, and
the second learning model is trained using the character string of the second purchase items and the cost category information of the second purchase items as second learning data.

8. The method of claim 1, wherein at least one of the first learning model and the second learning model includes a convolutional neural network (CNN).

9. The method of claim 1, wherein the cost category information includes a plurality of hierarchical categories.

10. The method of claim 1, further comprising:
receiving a user input related to at least one of “epoch number,” “CNN filters number,” “CNN filters output,” “CNN dropout,” “FCN hidden units,” “Batch size,” and “learning rate,”
wherein at least one of the first learning model and the second learning model is trained based on the user input.

11. An electronic apparatus comprising:
a memory; and
a processor electrically connected to the memory,
wherein the processor is configured to:
acquire statement data related to purchase items;
extract a character string related to attributes of the items from the statement data;
check at least one item corresponding to an indirect cost among the items from a feature vector using at least one learning model trained through machine learning; and
check information about a cost category of the at least one item.

12. A computer-readable non-transitory recording medium recording a program for executing a method of providing information based on machine learning on a computer,
wherein the method of providing information based on machine learning comprises:
acquiring statement data related to purchase items;
extracting a character string related to attributes of the items from the statement data;
checking at least one item corresponding to an indirect cost among the items based on the character string by using a first learning model trained through machine learning; and
checking cost category information of the at least one item based on the character string by using a second learning model trained through machine learning.
